(19) United States
(12) Patent Application Publication
(10) Pub. No.: US 2025/0371106 A1
(43) Pub. Date: Dec. 4, 2025

(54) INFORMATION PROCESSING APPARATUS, INFORMATION PROCESSING METHOD, AND NON-TRANSITORY COMPUTER READABLE MEDIUM

(71) Applicant: KABUSHIKI KAISHA TOSHIBA, Tokyo (JP)

(72) Inventor: Kento KOTERA, Kawasaki Kanagawa (JP)

(73) Assignee: KABUSHIKI KAISHA TOSHIBA, Tokyo (JP)

(21) Appl. No.: 19/065,078

(22) Filed: Feb. 27, 2025

(30) Foreign Application Priority Data
May 30, 2024 (JP) 2024-088379

(51) Int. Cl. G06F 18/213; G06F 123/02

(52) U.S. Cl. CPC G06F 18/213; G06F 2123/02; G06F 2218/10

(57) ABSTRACT

An information processing apparatus for a measurement target transitioning between a first state and a second state, comprising processing circuitry to: generate first distance information based on measurement waveform data including first data points and reference waveform data including second data points related to the first state, including distances between the first and the second data points; determine corresponding second data points for each first data point to generate first correspondence data; replace a distance between at least one target data point selected from the second data points and one or more of the first data points with a setting value to generate second distance information; determine corresponding second data points for each first data point based on the second distance information to generate second correspondence data; and detect an interval in which the measurement target is in the second state based on the first and the second correspondence data.

### CROSS REFERENCE TO RELATED APPLICATIONS

This application is based upon and claims the benefit of priority from the prior Japanese Patent Application No. 2024-088379, filed on May 30, 2024, the entire contents of which are incorporated herein by reference.

### FIELD

Embodiments described herein relate to an information processing apparatus, an information processing method, and a computer program.

### BACKGROUND

In time-series waveform data such as patient's electrocardiogram data and pressure data of a propulsion apparatus of a spacecraft, in which a certain waveform pattern is repeated at predetermined periods, there exists a type of anomaly (partial anomaly) in which part of the waveform pattern collapses. By monitoring the time-series waveform data, it is possible to detect a period of the waveform pattern in which an anomaly has occurred. In this event, there is a demand to detect an interval from start to end of the occurrence of the anomaly in the waveform pattern in which the anomaly has occurred. In other words, there is a demand to detect a state (for example, normality or anomaly) of some intervals in the waveform pattern.

### BRIEF DESCRIPTION OF THE DRAWINGS

FIG. 1 is a view for explaining outline of operation of an information processing apparatus according to Embodiment 1.

FIG. 2 is a block diagram illustrating a configuration of the information processing apparatus according to Embodiment 1.

FIG. 3 is a view illustrating an example of normal measurement waveform data and reference waveform data.

FIG. 4 is a view illustrating an example of measurement waveform data and reference waveform data including a partial anomaly.

FIG. 5 is a view illustrating an example of a first cost matrix.

FIG. 6 is a view illustrating an example of a first DTW matrix.

FIG. 7 is a view for explaining a setting method for setting values.

FIG. 8 is a view illustrating an example of a second cost matrix.

FIG. 9 is a view illustrating an example of a second DTW matrix.

FIG. 10 is a view for explaining a relationship between a first similarity and a second similarity.

FIG. 11 is a flowchart for explaining operation of the information processing apparatus according to Embodiment 1.

FIG. 12 is a block diagram illustrating a configuration of an information processing apparatus according to Embodiment 2.

FIG. 13 is a block diagram illustrating a detailed configuration of the second similarity calculator.

FIG. 14 is a view illustrating an example of an inverse DTW matrix.

FIG. 15 is a view illustrating an example of a forward DTW matrix.

FIG. 16 is a view for explaining a method for calculating an evaluation vector.

FIG. 17 is a view illustrating a configuration of an information processing system according to Embodiment 3.

FIG. 18 is a view illustrating a hardware configuration of the information processing apparatus according to each embodiment.

### DETAILED DESCRIPTION

According to one embodiment, an information processing apparatus includes processing circuitry. The processing circuitry generates first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points. The processing circuitry determines one or more corresponding second data points for each of the first data points based on the first distance information to generate first correspondence data in which the first data points are associated with the second data points. The processing circuitry
replaces a distance between at least one target data point and one or more of the first data points with a setting value corresponding to each target data point to generate second distance information, the at least one target data point being at least one second data point selected from the plurality of second data points. The processing circuitry determines one or more corresponding second data points for each of the first data points based on the second distance information to generate second correspondence data in which the first data points are associated with the second data points. The processing circuitry evaluates the measurement waveform data based on the first correspondence data and the second correspondence data to detect an interval in which the measurement target is in the second state in the measurement waveform data.

Hereinafter, embodiments of the present invention will be described with reference to the drawings. In the drawings, the same reference numerals are assigned to the same or corresponding elements, and detailed description will be omitted as appropriate.

### Embodiment 1

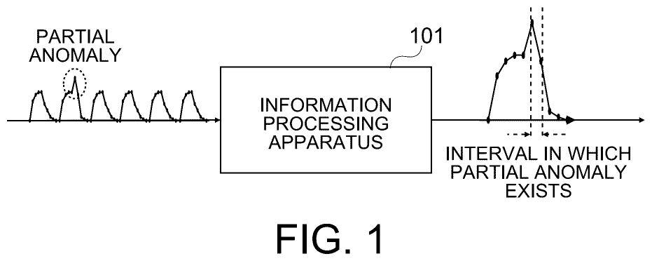

FIG. 1 is a view for explaining outline of operation of an information processing apparatus 101 according to Embodiment 1. Periodic time-series data measured from a certain measurement target is input to the information processing apparatus 101, for example. In the periodic time-series data, waveforms of almost identical patterns repeatedly appear. Examples of such time-series data include patient's electrocardiogram data, pressure data of a propulsion apparatus of a spacecraft, and sensing data from equipment that repeatedly performs a plurality of processes at certain periods.

In a case of the electrocardiogram data, the length of a waveform in a time direction included in one period expands and contracts according to a heart rate of the patient, but when the lengths of respective waveforms in the time direction are properly adjusted, the waveforms generally match. In a case of the pressure data of the propulsion apparatus, the length of a waveform in a time direction included in one period expands and contracts according to output of the propulsion apparatus, but when the lengths of respective waveforms in the time direction are properly adjusted, the waveforms generally match.

In a case of the electrocardiogram data, if the patient experiences arrhythmia, deformation occurs in part of the periodic waveform pattern. In a case of the pressure data of the propulsion apparatus, if knocking occurs in the propulsion apparatus, deformation occurs in part of the periodic waveform pattern. Further, in the equipment that performs a plurality of processes, in a case where an anomaly occurs in some processes, deformation occurs in a part corresponding to the processes in the waveform pattern. The information processing apparatus 101 detects partial deformation of such waveform patterns as a partial anomaly, and detects an interval in which the partial anomaly exists in the time-series data. In other words, the information processing apparatus 101 detects an interval in which a measurement target is in a second state (for example, an anomaly state) different from a first state (for example, regular state or a normal state). However, a state for which the interval is to be detected (the second state) is not limited to the anomaly state, and it is sufficient if the state for which the interval is to be detected is a state different from the regular state. For example, the state for which the interval is to be detected may be a state that is a precursor to an anomaly, or a state in which degradation has progressed significantly.

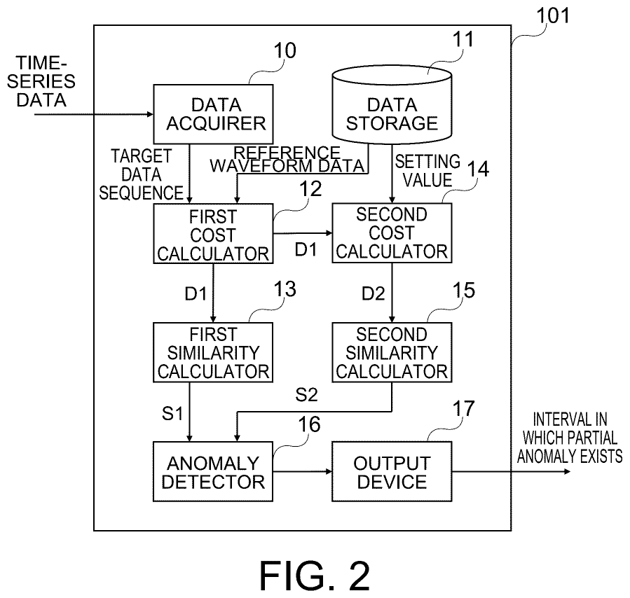

FIG. 2 is a block diagram illustrating a configuration of the information processing apparatus 101 according to Embodiment 1. The information processing apparatus 101 includes a data acquirer 10, a data storage 11, a first cost calculator 12, a first similarity calculator 13, a second cost calculator 14, a second similarity calculator 15, an anomaly detector 16, and an output device 17.

Some or all of the data acquirer 10, the data storage 11, the first cost calculator 12, the first similarity calculator 13, the second cost calculator 14, the second similarity calculator 15, the anomaly detector 16, and the output device 17 constitute a processor or processing circuitry, that performs processing according to the present embodiment.

In data acquirer 10, periodic time-series data measured by a sensor that senses a measurement target that is put into both the first state and the second state is input. The time-series data is sampled in a time direction at a predetermined sampling frequency and quantized in an amplitude direction with a predetermined number of bits. The data acquirer 10 sequentially extracts, from the periodic time-series data, measurement waveform data corresponding to each period of the periodic time-series data. Each piece of the measurement waveform data includes M data points (first data points) from the first to the M-th data points. The first of the first data points corresponds to the initial first data point, and the M-th of the first data points corresponds to the last first data point.

In the data storage 11, reference waveform data including M data points (second data points) from the first to the M-th data points, related to the first state (for example, a normal state), and predetermined setting values respectively corresponding to the M data points (details will be described later) are stored in advance. The first of the second data points in the reference waveform data corresponds to the initial second data point, and the M-th of the second data points corresponds to the last second data point. In Embodiment 1, a case will be described where the number of data points of the measurement waveform data is equal to the number of data points of the reference waveform data, but the number of data points of both may be different.

A method for creating the reference waveform data is not particularly limited. For example, the reference waveform data can be created by sequentially extracting, from the periodic time-series data measured from a measurement target in a normal state, test waveform data corresponding to one period of the periodic time-series data and obtaining a centroid waveform (barycenter) of the plurality of pieces of test waveform data. As the method for obtaining the centroid waveform, for example, a 15 soft-DTW method and a DBA method can be used.

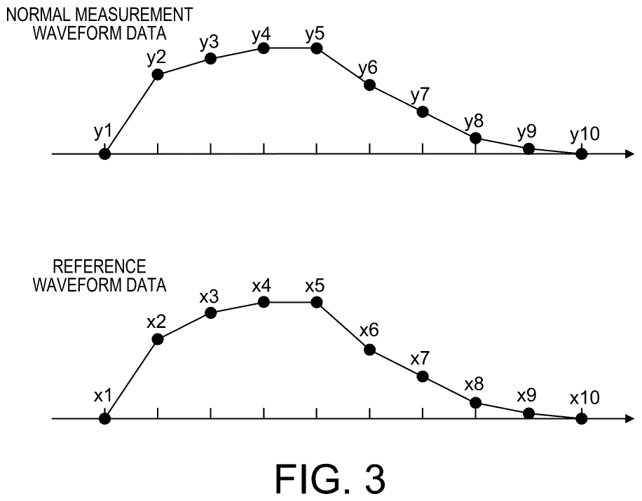

FIG. 3 illustrates an example of normal measurement waveform data in a case where M=10 and an example of the reference waveform data. An upper part of FIG. 3 is the normal measurement waveform data, and a lower part of FIG. 3 is the reference waveform data. Comparing the two kinds of waveform data, they generally match.

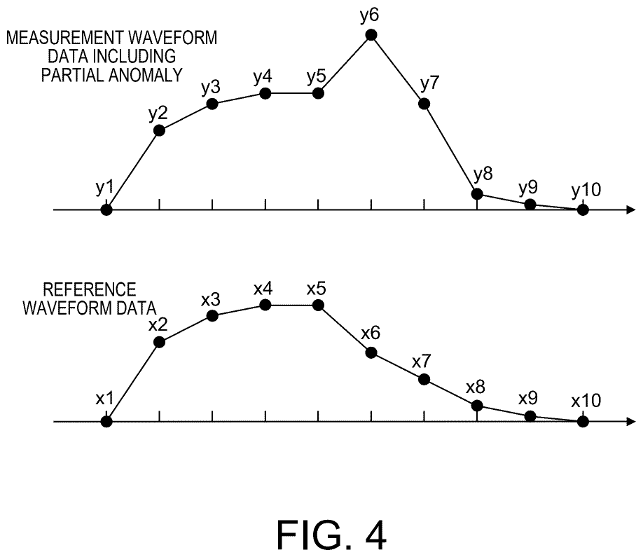

FIG. 4 illustrates an example of the measurement waveform data including a partial anomaly in a case where M=10, and an example of the reference waveform data. An upper part of FIG. 4 is the measurement waveform data including a partial anomaly, and a lower part of FIG. 4 is the reference waveform data. Comparing the two kinds of waveform data, there is a significant discrepancy in the sixth and seventh data points corresponding to the partial anomaly included in the measurement waveform data.

The first cost calculator 12 calculates a distance between M data points (first data points) included in the measurement waveform data and M data points (second data points) included in the reference waveform data. More specifically, for each of the M first data points included in the measurement waveform data, a distance to each of the M second data points included in the reference waveform data is calculated. The first cost calculator 12 generates distance information (first distance information) that includes each distance between the first data point and the second data point based on the calculated distance.

Here, as the first distance information, a matrix (first distance matrix) having a size of M×M, in which the calculated distances are stored in the corresponding elements for each pair of the first data point and the second data point is generated. More specifically, the distance between the first data point and the second data point is defined as cost, and a matrix (first cost matrix D1) in which the cost is stored in the corresponding elements for each pair of the first data point and the second data point is calculated.

In general, a distance δ(x, y) between two data points x and y, that is, cost, can be defined as follows using γ as a parameter of a real number.

$$δ ( x , y ) = {\vert x - y \vert}^{γ} \qquad [ Math . 1 ]$$

In Embodiment 1, a case where γ=1 in the above formula, that is, a Euclidean distance is considered as the cost. In this case, if the reference waveform data is set as {x1, x2, . . . xM} and the measurement waveform data is set as {y1, y2, . . . yM}, the first cost matrix D1 is calculated as follows.

$$D 1 {( i , j )}_{1 \leq i , j \leq M = \vert {x}_{i} - {y}_{i} \vert} \qquad [ Math . 2 ]$$

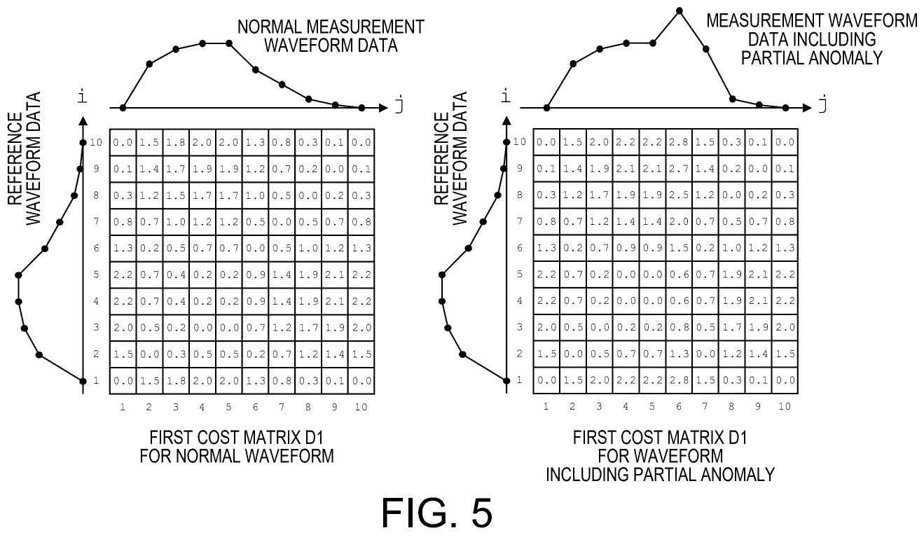

FIG. 5 illustrates two examples of the first cost matrix D1 (first distance information or first distance matrix). A left part of FIG. 5 is the first cost matrix D1 calculated from the normal measurement waveform data and the reference waveform data. A right part of FIG. 5 is the first cost matrix D1 calculated from the measurement waveform data including a partial anomaly and reference waveform data. The element in the i-th row and j-th column of the first cost matrix D1 is represented as an element (i, j). For example, the element in the sixth row and sixth column of the first cost matrix D1 in the right part of FIG. 5 is an element (6, 6), and a value of the element (6, 6) is 1.5. The value of the element (6, 6) being 1.5 indicates that the distance (cost) between the sixth data point x1 of the reference waveform data and the sixth data point y6 of the measurement waveform data including a partial anomaly, is 1.5.

The first similarity calculator 13 determines one or more corresponding second data points for each first data point based on the first cost matrix D1, and generates first correspondence data indicating correspondence between each first data point and the determined second data points. For example, the first similarity calculator 13 generates the first correspondence data by, for each first data point, searching for one or more corresponding second data points so that a sum of distances to the corresponding second data points is minimized, and all the second data points are associated with at least one first data point. Then, the first similarity calculator 13 calculates a first evaluation value using the sum of distances between the corresponding first data points and the second data points included in the first correspondence data. The first evaluation value corresponds to the first similarity S1 between the measurement waveform data and the reference waveform data in the present embodiment, but may be a value other than similarity. The processing of the first similarity calculator 13 will be described in more detail below.

In Embodiment 1, generation of the first correspondence data and calculation of the first similarity S1 are performed using dynamic time warping (DTW) from the first cost matrix D1. One of the characteristics of the DTW is its robustness to stretching and phase shift in a time direction. By using the DTW, even in a case where lengths of the measurement waveform data and the reference waveform data are different, or in a case where their phases are shifted, it is possible to calculate the similarity of two kinds of waveform data while taking these factors into account.

In detail, the first similarity calculator 13 calculates a first DTW matrix V1 from the first cost matrix D1 according to the following formula.

$$V 1 {( i , j )}_{1 \leq i , j \leq M} = D 1 ( i , j ) + min [ \begin{matrix}V 1 ( i - 1 , j - 1 ) \\ V 1 ( i - 1 , j ) \\ V 1 ( i , j - 1 )\end{matrix} ] \qquad [ Math . 3 ]$$

In other words, starting from the element corresponding to a pair of the initial first data point and the initial second data point in the first cost matrix D1 (first distance matrix), tracing of each adjacent element from the starting point is sequentially repeated. From the starting point, a path that minimizes a sum of distances of the elements included in the path to elements other than the starting point is specified, and the sum of distances of the elements included in the specified path is calculated as a DTW value (first intermediate evaluation value). Then, by storing the DTW value calculated for each element in the corresponding element, a first DTW matrix V1 (first evaluation matrix) is generated. A value of the element corresponding to the pair of the initial first data point and the initial second data points in the first DTW matrix V1 may be the same as the value at the starting point of the first cost matrix D1.

A value of the end point (M, M) of the first DTW matrix V1 (the element corresponding to the pair of the last first data point and the last second data point) is the first similarity S1 (first evaluation value). When the first DTW matrix V1 is generated, correspondence between the first data point and the second data point indicated by each element included in the path traced from the starting point to the end point in the first cost matrix D1 corresponds to the above-described first correspondence data. Then, the sum of distances indicated by each correspondence included in the first correspondence data becomes the first similarity S1 (first evaluation value). As a difference between the measurement waveform data and the reference waveform data is smaller, the first similarity S1 becomes smaller, and in a case where both completely match, the first similarity S1 becomes zero. On the contrary, as the difference between the measurement waveform data and the reference waveform data is larger, the first similarity S1 becomes larger.

Note that in the present embodiment, the similarity (evaluation value) is defined such that as the similarity (evaluation value) is larger, the difference between the measurement waveform data and the reference waveform data is larger. However, the similarity (evaluation value) may also be defined such that as the similarity (evaluation value) is larger, the measurement waveform data becomes closer to the reference waveform data.

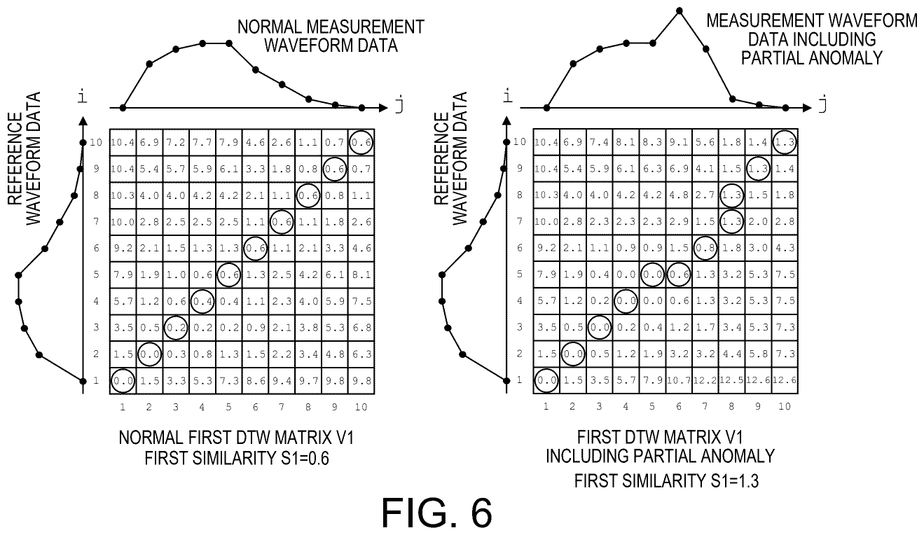

FIG. 6 illustrates two examples of the first DTW matrix V1 (first evaluation matrix). A left part of FIG. 6 is the first DTW matrix V1 calculated from the normal measurement waveform data, and a value at the end point (10, 10) is 0.6, and thus, the first similarity S1 is 0.6. A right part of FIG. 6 is the first DTW matrix V1 calculated from the measurement waveform data including a partial anomaly, and a value at the end point (10, 10) is 1.3, and thus, the first similarity S1 is 1.3.

In each first DTW matrix V1 in FIG. 6, the elements enclosed by solid circles represent the path (referred to as an optimal path) that minimizes a sum of cost (distance) from the starting point (1, 1) to the end point (10, 10). This optimal path corresponds to the above-described first correspondence data. More specifically, the correspondence between the first data point and the second data point indicated by each element included in the optimal path corresponds to the first correspondence data. The first similarity S1 corresponds to the first evaluation value calculated from the first correspondence data.

The optimal path for the first DTW matrix V1 represents a maximum likelihood correspondence relationship between each data point included in the reference waveform data and each data point included in the measurement waveform data. For example, in a case of the first DTW matrix V1 in the right part of FIG. 6, the first to fourth data points of the reference waveform data (first data points) correspond to the first to fourth data points of the measurement waveform data (second data points), respectively. The fifth data point of the reference waveform data corresponds to two data points, namely the fifth and sixth data points of the measurement waveform data. The sixth to seventh data points of the reference waveform data correspond to the seventh to eighth data points of the measurement waveform data, respectively. The eighth to tenth data points of the reference waveform data correspond to the eighth to tenth data points of the measurement waveform data, respectively.

The second cost calculator 14 calculates the second cost matrix D2 by replacing some of the elements in the first cost matrix D1 with setting values corresponding to the second data points for those elements. More specifically, the second cost calculator 14 selects at least one second data point from a plurality of second data points included in the reference waveform data as a target data point, and replaces a distance (cost) between the target data point and one or more first data points in the first cost matrix D1 with a setting value corresponding to the target data point. In Embodiment 1, the second cost calculator 14 selects all elements from the p-th row to the q-th row of the first cost matrix D1, and calculates the second cost matrix D2 by replacing the values of the respective elements with the setting values corresponding to the second data points for each row. The second cost matrix D2 corresponds to the second distance information or second distance matrix, obtained by replacing the distances (cost) between the target data point and one or more first data points in the first cost matrix D1 with setting values corresponding to the target data point.

In the data storage 11 described above, M setting values {r1, r2, . . . rM} corresponding to M data points (the second data points) included in the reference waveform data are stored in advance. The setting values have values according to an expected range of the distance to the first data point with which the second data point is associated in the processing of the first similarity calculator 13 in the measurement waveform data obtained in a case where the measurement target is in a normal state. For example, the setting values have values greater than or equal to an upper limit of the range.

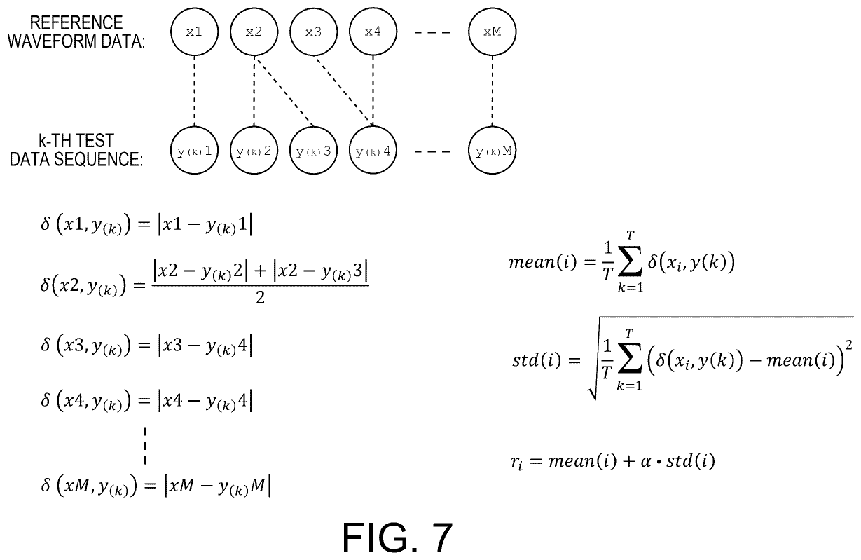

FIG. 7 is a view for explaining a method for generating or determining M setting values.

First, T pieces of test waveform data including M data points (third data points) related to the first state (for example, the normal state) are prepared. The method for creating the test waveform data is not particularly limited, and, for example, the test waveform data used to create the reference waveform data above can be reused as is.

Next, for each piece of the test waveform data, a maximum likelihood correspondence relationship between the M data points (second data points) included in the reference waveform data and the M data points (third data points) included in the test waveform data is determined by the DTW. In the example of FIG. 7, a data point x1 of the reference waveform data corresponds to a data point y₍ₖ₎1 of the test waveform data y(k), a data point x2 of the reference waveform data corresponds to data points y₍ₖ₎2 and y₍ₖ₎3 of the test waveform data y(k), a data point x3 of the reference waveform data corresponds to a data point y₍ₖ₎4 of the test data example y(k), and a data point x4 of the reference waveform data corresponds to a data point y₍ₖ₎4 of the test waveform data y(k). Similarly, a data point xM of the reference waveform data corresponds to a data point y₍ₖ₎M of the test waveform data y(k).

Next, an average mean (i) and a standard deviation std (i) of a distance δ(xi, y(k)) between the i-th data point xi of the reference waveform data and one or more data points corresponding to the i-th data point of the test waveform data y(k) is calculated.

$$mean ( i ) = \frac{1}{T} {\sum }_{k = 1}^{T} δ ( {x}_{i} , y ( k ) ) \qquad [ Math . 4 ]$$

$$std ( i ) = \sqrt{\frac{1}{T} {\sum }_{k = 1}^{T} {( δ ( {x}_{i} , y ( k ) ) - mean ( i ) )}^{2}} \qquad [ Math . 5 ]$$

Finally, for M setting values {r1, r2, . . . rM}, the i-th setting value ri is calculated by adding a certain margin, such as a times of the standard deviation, to an average distance (average cost) between the i-th data point of the reference waveform data and one or more data points corresponding to the i-th data point of the test waveform data. A value of a parameter a is, for example, preferably around 3.0.

$${r}_{i} = mean ( i ) + α \cdot std ( i ) \qquad [ Math . 6 ]$$

A method for generating the M setting values {r1, r2, . . . rM} is not limited to the above method, and various modifications and adjustments can be made to the above method. Alternatively, a method that is completely different from the above-described method may be used.

The second cost calculator 14 sets an interval [p, q] defined by positive integers p and q that satisfy the relationship 1≤p≤q≤M, and for all positive integers i∈ [p, q], replaces a value of each element in the i-th row of the first cost matrix D1 with the i-th setting value ri. As a result, for each combination of p and q, the second cost matrix D2 (second distance information or second distance matrix) is calculated.

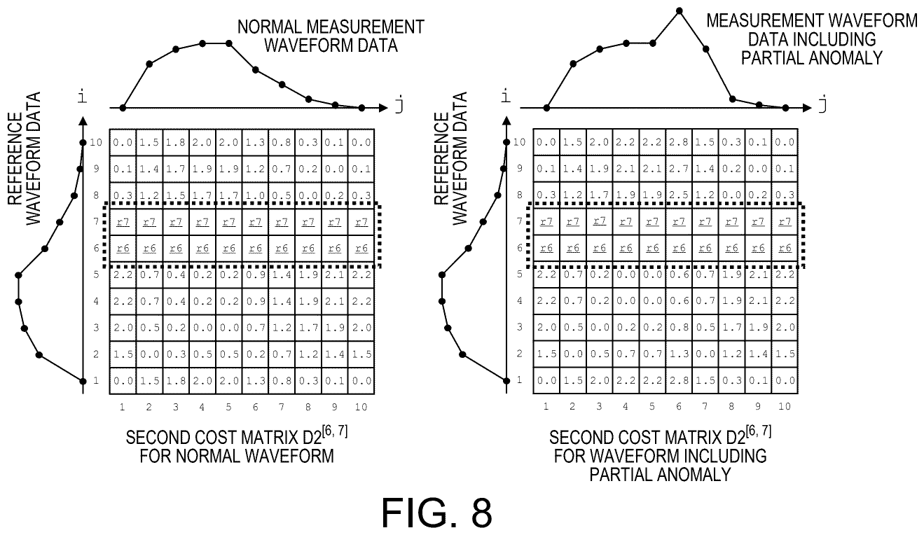

FIG. 8 illustrates two examples of the second cost matrix D2 in a case where p=6 and q=7. In this case, each element of the sixth row of the first cost matrix D1 is replaced with the sixth setting value r6, and each element of the seventh row of the first cost matrix D1 is replaced with the seventh setting value r7. In the present embodiment, the values (cost) of all elements are replaced in row unit, but only the values (cost) of one or more specific elements may be replaced. For example, the values of the leftmost and rightmost elements of the elements in a certain row do not need to be replaced.

In Embodiment 1, M=10, and thus, for the interval [p, q], there are 45 patterns in a case where p<q (represented as ₁₀C₂), and 10 patterns in a case where p=q, that is, a total of 55 patterns. The second cost calculator 14 calculates 55 patterns of the second cost matrix D2 corresponding to these 55 intervals [p, q]. In other words, a plurality of second cost matrices D2 are calculated for one first cost matrix D1. Hereinafter, the second cost matrix D2, in which the values of the elements related to the interval [p, q] in the first cost matrix D1 are replaced with the setting values, will be denoted as “D2^{[p,q]} ” as needed. Please note that this notation does not represent the element (p, q) of the second cost matrix D2.

The second similarity calculator 15 calculates a plurality of second similarities S2 (second evaluation values) corresponding to a plurality of second cost matrices D2 calculated for a plurality of intervals [p, q] that satisfy the relationship 1≤p≤q≤M. It is only necessary that the method for calculating the second similarity S2 is performed using the DTW from the second cost matrix D2 in a similar manner to a case of the first similarity S1. While details have been as described above, description will be provided again.

Based on the second cost matrix D2, one or more corresponding second data points for each first data point are determined, and second correspondence data (optimal path) that indicates the correspondence between each first data point and the determined second data points is generated. For example, by searching for one or more second data points corresponding to each first data point so that a sum of distances to the corresponding second data points is minimized, and all the second data points are associated with at least one first data point, the second correspondence data is generated. Then, the second evaluation value is calculated as the second similarity S2 using the sum of distances between the corresponding first data points and second data points included in the second correspondence data.

In other words, starting from the element corresponding to a pair of the initial first data points and the initial second data point in the second cost matrix D2, tracing of each adjacent element from the starting point is sequentially repeated. From the starting point, the path that minimizes the sum of distances of the elements included in the path to elements other than the starting point is specified, and the sum of distances of the elements included in the specified path is calculated as a DTW value (second intermediate evaluation value). Then, by storing the DTW values calculated for each element in their corresponding elements, the second DTW matrix V2 (second evaluation matrix) is generated. The value of the element corresponding to the pair of the initial first data point and the initial second data point in the second DTW matrix V2 may be the same as the value of the starting point of the second cost matrix D2. The value of the end point (M, M) of the second DTW matrix V2 (corresponding to the pair of the last first data point and the last second data point) is the second similarity S2 (second evaluation value). When the second DTW matrix V2 is generated, the correspondence between the first data point and the second data point indicated by each element included in the path (optimal path) traced from the starting point to the end point in the second cost matrix D2 corresponds to the second correspondence data described above. Then, the sum of distances related to each correspondence included in the second correspondence data becomes the second similarity S2 (second evaluation value).

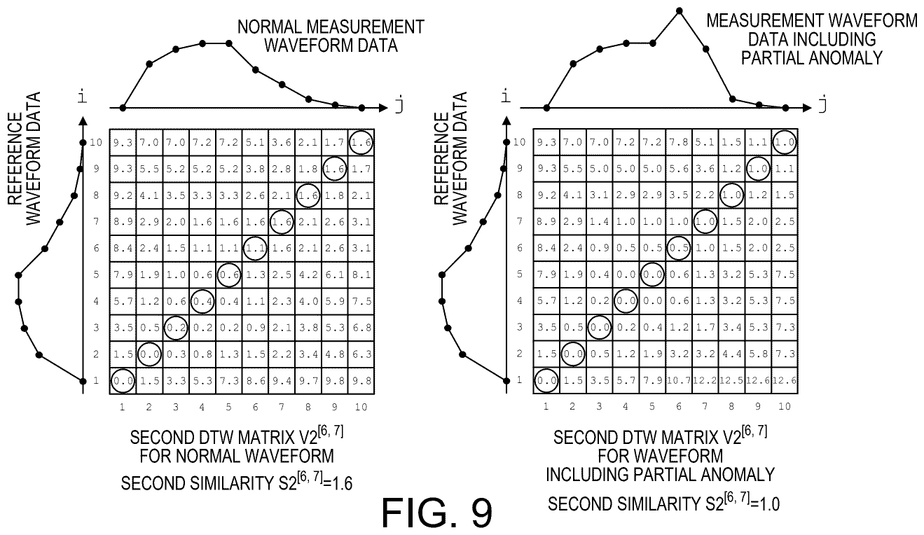

FIG. 9 is a view illustrating an example of the second DTW matrix V2^{[6, 7]} and the second similarity S2^{[6, 7]} calculated corresponding to the second cost matrix D2^{[6, 7]} related to the interval [6, 7]. Two examples are illustrated: one for a normal waveform (left) and one for a waveform including a partial anomaly (right). A left part of FIG. 9 is an example of the second DTW matrix V2^{[6, 7]} calculated from normal measurement waveform data, and a value of the end point (10, 10) is 1.6, and thus, the second similarity S2^{[6, 7]} (second evaluation value) is 1.6. A right part of FIG. 9 is an example of the second DTW matrix V2^{[6, 7]} calculated from the measurement waveform data including a partial anomaly, and a value of the end point (10, 10) is 1.0, and thus, the second similarity S2^{[6, 7]} (second evaluation value) is 1.0.

The anomaly detector 16 detects the interval in which the measurement target is in the second state (in this case, an anomaly state) in the measurement waveform data, by evaluating the measurement waveform data based on the optimal path specified in the first DTW matrix V1 (first correspondence data) and the optimal path specified in the second DTW matrix V2 (second correspondence data). Based on the first similarity S1 (first evaluation value) and a plurality of second similarities S2 (second evaluation values), it is determined whether there is an interval in an anomaly state in the measurement waveform data. In a case where there is an interval in an anomaly state, the interval of the measurement waveform data corresponding to the interval [P, Q] related to the second similarity S2^{[P, Q]} will be determined as the interval in an anomaly state. The interval of the measurement waveform data corresponding to the interval [P, Q] related to the second similarity S2^{[P, Q]} includes the first data point corresponding to the target data point (second data point included in the interval [P, Q]) in the second correspondence data (optimal path), which is the interval of the measurement waveform data. The processing of the anomaly detector 16 will be described in detail below.

The anomaly detector 16 selects a second similarity S2 with the highest evaluation (the best one) from among a plurality of second similarities S2, that is, a second similarity S2 with the smallest value, and checks whether or not the second similarity S2 with the smallest value is smaller than the first similarity S1 by equal to or greater than a threshold. In other words, the anomaly detector 16 checks whether a difference between the first similarity S1 and the second similarity S2 with the smallest value is equal to or greater than the threshold (whether or not the best second similarity S2 has improved by equal to or greater than the threshold compared to the first similarity S1).

For example, a case where the second similarity with the smallest value is S2^{[P, Q]} will be considered. As described above, the second cost matrix D2^{[P, Q]} corresponding to the second similarity S2^{[P, Q]} with the smallest value is calculated by replacing the value of each element in the i-th row of the first cost matrix D1 with the i-th setting value ri for all positive integers i∈[P, Q]. This operation corresponds to replacing each distance (cost) between the i-th data point of the reference waveform data and the first to M-th data points of the measurement waveform data with a distance (cost) that adds a certain margin to an average distance (average cost) between the i-th data point of the reference waveform data and the corresponding data points of a plurality of pieces of test waveform data.

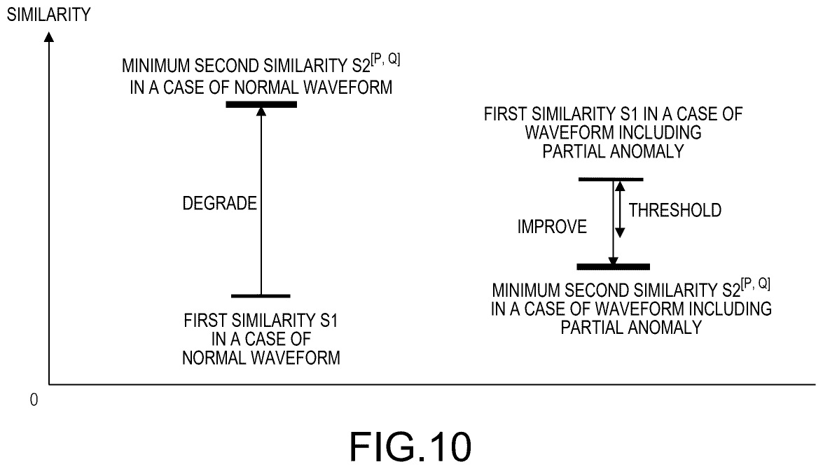

Thus, in a case where the replacement above is made when the measurement waveform data is normal measurement waveform data, as illustrated in the left part of FIG. 10, even the second similarity S2^{[P, Q]} with the smallest value should be greater than the first similarity S1. In other words, even the best second similarity S2^{[P, Q]} should be degraded compared to the first similarity S1.

In contrast, as illustrated in the right part of FIG. 10, if the second similarity S2^{[P, Q]} with the smallest value is smaller than the first similarity S1 by equal to or greater than the threshold, in other words, if the best second similarity S2^{[P, Q]} has improved compared to the first similarity S1 by equal to or greater than the threshold, it means that each distance (cost) between the i-th data point of the reference waveform data and the first to M-th data points of the measurement waveform data is greater than the distance (cost) with a certain margin added to the average distance (average cost) between the i-th data point of the reference waveform data and the corresponding data points of the test waveform data. This means that there is an anomaly in the interval of the measurement waveform data corresponding to the interval [P, Q] of the reference waveform data (the measurement target is in an anomaly state). For example, in a case where P=6 and Q=7, by referring to the second DTW matrix V2(i, j) in the right part of FIG. 9, it is determined that there is an anomaly in the interval [6, 7] of the measurement waveform data corresponding to the interval [6, 7] of the reference waveform data.

In summary, in a case where the second similarity S2^{[P, Q]} with the smallest value is smaller than the first similarity S1 by equal to or greater than the threshold (in a case where a difference between the first similarity S1 and the second similarity S2^{[P, Q]} with the smallest value is equal to or greater than the threshold), in other words, if the best second similarity S2^{[P, Q]} has improved by equal to or greater than the threshold compared to the first similarity S1, the anomaly detector 16 determines that there is an anomaly in the interval of the measurement waveform data corresponding to the interval [P, Q] related to the second similarity S2^{[P, Q]} of the reference waveform data.

On the other hand, in a case where the second similarity S2^{[P, Q]} with the smallest value is not smaller than the first similarity S1 by equal to or greater than the threshold (that is, the difference between the first similarity S1 and the second similarity S2^{[P, Q]} with the smallest value is less than the threshold), in other words, if the best second similarity S2^{[P, Q]} has not improved by equal to or greater than the threshold compared to the first similarity S1, the anomaly detector 16 determines that there is no anomaly in the interval of the measurement waveform data corresponding to the interval [P, Q] (the measurement target is not in an anomaly state), that is, the measurement target is in a normal state.

The output device 17 displays the interval in which the anomaly exists in a case where it is determined by the anomaly detector 16 that the measurement waveform data includes an anomaly in the above interval. The information to be displayed may, for example, indicate the interval in which the anomaly exists in association with the measurement waveform data.

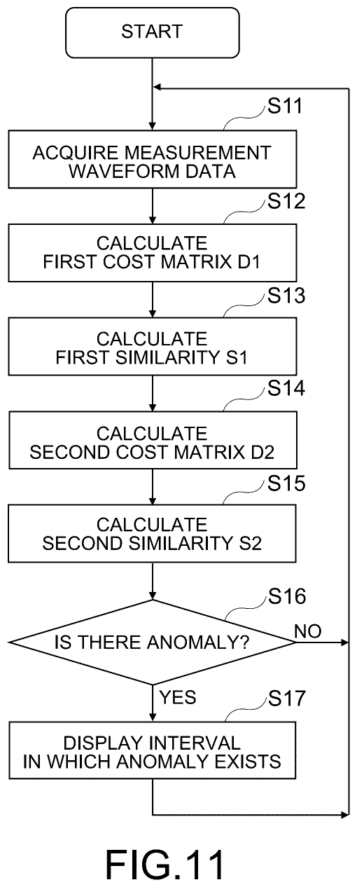

FIG. 11 is a flowchart for explaining operation of the information processing apparatus 101 according to Embodiment 1.

In step S11, the data acquirer 10 sequentially extracts, from the periodic time-series data, a plurality of pieces of measurement waveform data corresponding to one period of the periodic time-series data and sequentially starts processing.

In step S12, the first cost calculator 12 calculates the first cost matrix D1 (first distance information or first distance matrix) based on the distances (cost) between M data points included in the measurement waveform data that is being currently processed and M data points included in the reference waveform data.

In step S13, the first similarity calculator 13 calculates the first similarity S1 (first evaluation value) between the measurement waveform data that is being currently processed and the reference waveform data based on the first cost matrix D1.

In step S14, the second cost calculator 14 replaces some elements of the first cost matrix D1 with predetermined setting values to calculate a plurality of second cost matrices D2. In other words, considering the interval [p, q] defined by positive integers p and q satisfying the relationship 1≤p≤q≤M, and for all positive integers i∈[p, q], the second cost matrix D2 is calculated by replacing each element in the i-th row of the first cost matrix D1 with the i-th setting value ri. By performing this calculation for all intervals [p, q] that satisfy the relationship 1≤p≤q≤M, a plurality of second cost matrices D2 (second distance information or second distance matrices) are obtained.

In step S15, the second similarity calculator 15 calculates a plurality of second similarities S2 corresponding to the plurality of second cost matrices D2.

In step S16, the anomaly detector 16 checks whether or not the measurement waveform data that is being currently processed includes an anomaly based on the first similarity S1 and the plurality of second similarities S2. For example, the second similarity S2 with the highest evaluation is selected among the plurality of second similarities S2, and in a case where a difference between the first similarity S1 and the second similarity S2 is equal to or greater than a threshold, it is determined that an anomaly is included, and in a case where the difference is less than the threshold, it is determined that no anomaly is included.

In a case where the measurement waveform data that is being currently processed includes an anomaly (S16=YES), the output device 17 displays an interval in which the anomaly exists (step S17), and the processing returns to step S11. The interval is an interval of the measurement waveform data corresponding to the interval [p, q] for which the selected second similarity S2 is calculated. More specifically, the interval is an interval of the measurement waveform data that includes the first data point corresponding to the second data point within the interval [p, q] in the optimal path (second correspondence data) corresponding to the interval [p, q].

On the other hand, in a case where the measurement waveform data that is being currently processed does not include an anomaly (S16=NO), the output device 17 does not display anything, and the processing returns to step S11.

As described above, the information processing apparatus 101 according to the present embodiment 1 calculates the first cost matrix D1 based on the distances (cost) between a plurality of data points included in the measurement waveform data and a plurality of data points included in the reference waveform data, and from the first cost matrix D1, calculates the first similarity S1 between the measurement waveform data and the reference waveform data. The information processing apparatus 101 replaces a value (cost) of the element corresponding to each interval [p, q] in the first cost matrix D1 with a predetermined setting value, calculates a plurality of second cost matrices D2, and from those plurality of second cost matrices D2, calculates a plurality of second similarities S2. The information processing apparatus 101 detects an anomaly included in the measurement waveform data and an interval in which the anomaly exists based on the first similarity S1 and the plurality of second similarities S2.

According to the above characteristics, the information processing apparatus 101 according to the present embodiment 1 can detect an anomaly included in the measurement waveform data and the interval in which the anomaly exists.

In addition, the information processing apparatus 101 replaces each distance (cost) between one or more data points included in the interval [p, q] of the reference waveform data and a plurality of data points included in the measurement waveform data with a predetermined setting value. The information processing apparatus 101 specifies that there is an anomaly in the interval of the measurement waveform data corresponding to the interval [p, q] of the reference waveform data.

According to the above characteristics, in a case where the measurement waveform data includes a partial anomaly, it is possible to specify the interval in which the partial anomaly exists.

In Embodiment 1, the first similarity S1 is calculated using the DTW from the first cost matrix D1. Similarly, the second similarity S2 is calculated from the second cost matrix D2 using the DTW. According to such characteristics, it is possible to specify an interval in which an anomaly exists in the measurement waveform data even in a case where the lengths of the measurement waveform data and the reference waveform data differ, or in a case where their phases are shifted.

In addition, the information processing apparatus 101 is equipped with a data acquirer 10 that sequentially extracts a plurality of pieces of measurement waveform data from periodic time-series data. According to such characteristics, it is possible to sequentially detect anomalies included in the periodic time-series data and intervals in which the anomalies exist.

In a case where an interval where an anomaly exists can be predicted, or in a case where it is desired to detect only an anomaly that exists in a specific interval, the above interval [p, q] may be restricted within a predetermined range of the reference waveform data. This makes it possible to reduce the number of patterns in the second cost matrix D2 and the second similarity S2. This results in making it possible to reduce a calculation amount of the second cost calculator 14 and the second similarity calculator 15.

### Other Configuration Examples of Embodiment 1

While in Embodiment 1 described above, whether or not there is an anomaly (state of the measurement target) in the interval of the measurement waveform data has been detected based on the difference between the first similarity S1 and the second similarity S2 (for example, the second similarity S2 with the highest evaluation), but other methods may also be used. For example, it is also possible to input the first correspondence data and the second correspondence data into a machine model learned in advance or artificial intelligence and obtain whether or not there is an anomaly as output. For example, for each of the normal and anomaly states of the measurement target, a difference between the first correspondence data and the second correspondence data, that is, a difference in the pattern (shape) of the optimal path corresponding to the first correspondence data and the second correspondence data, may be learned through machine learning, or the like, to construct a model for determining whether or not there is an anomaly.

### Embodiment 2

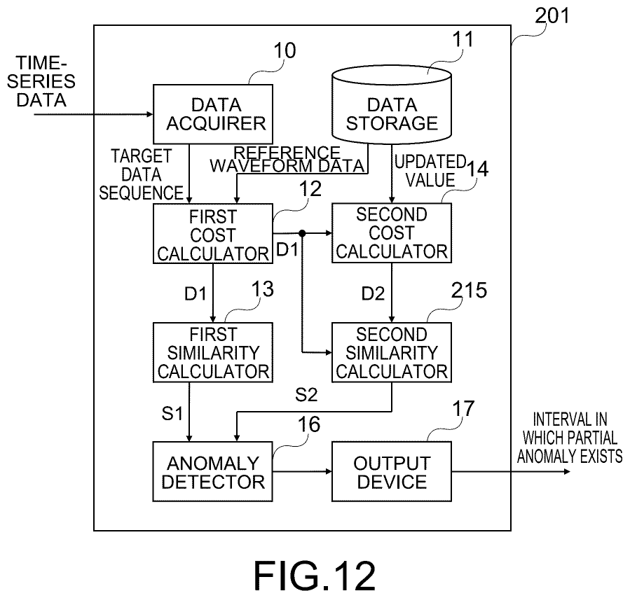

FIG. 12 is a block diagram illustrating a configuration of an information processing apparatus 201 according to Embodiment 2. The information processing apparatus 201 includes a second similarity calculator 215 instead of the second similarity calculator 15 of the information processing apparatus 101 in Embodiment 1. The second similarity calculator 215 calculates the second similarity S2^{[p, q+}1] related to the interval [p, q+1] by utilizing the already calculated second similarity S2^{[p, q]} related to the interval [p, q]. This makes it possible to reduce a calculation amount to calculate the second similarity S2^{[p, q+}1], so that it is possible to perform processing efficiently and in a short period of time.

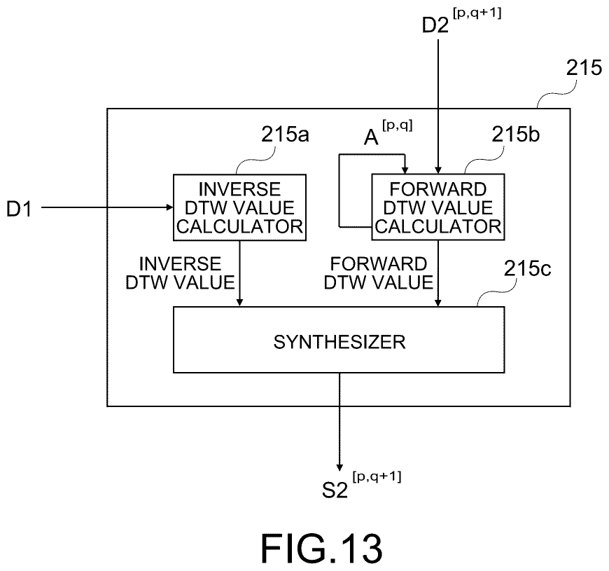

FIG. 13 is a block diagram illustrating a detailed configuration of the second similarity calculator 215. The second similarity calculator 215 includes an inverse DTW value calculator 215a, a forward DTW value calculator 215b, and a synthesizer 215c.

The inverse DTW value calculator 215a calculates the following DTW matrix according to the following formula from the first cost matrix D1, starting from (M, M) and ending at (1, 1). This DTW matrix is referred to as an inverse DTW matrix B (third evaluation matrix).

$${B ( i , j )}_{1 \leq i , j \leq M} = D 1 ( i , j ) + min [ \begin{matrix}B ( i + 1 , j + 1 ) \\ B ( i + 1 , j ) \\ B ( i , j + 1 )\end{matrix} ] \qquad [ Math . 7 ]$$

In other words, starting from the element corresponding to a pair of the last first data point and the last second data point, tracing of each adjacent element from the starting point is sequentially repeated. A path for which a sum of distances of the elements included in the path from the starting point to elements other than the starting point is minimized is specified, and a sum of distances of the elements included in the specified path is calculated as a DTW value (third intermediate evaluation value). Then, by storing the DTW value calculated for each element in the corresponding element, the inverse DTW matrix B (third evaluation matrix) is generated. Note that the value of the (M, M) of the inverse DTW matrix B may be the same as the value of the (M, M) of the first cost matrix D1.

There is only one first cost matrix D1, and thus, the processing of calculating the inverse DTW matrix B only needs to be performed once.

The inverse DTW value calculator 215a specifies the inverse DTW value from the end point (M, M) of the first cost matrix D1 to each element of the (q+2)-th row based on the inverse DTW matrix B. In detail, each element in the (q+2)-th row of the inverse DTW matrix B represents a sum of the cost to reach each element in the (q+2)-th row from the end point (M, M) of the first cost matrix D1 (third intermediate evaluation value). Thus, the inverse DTW value calculator 215a extracts the value of each element in the (q+2)-th row of the inverse DTW matrix B. In other words, based on the inverse DTW matrix B, the value of each element corresponding to the (q+2)-th second data point (third intermediate evaluation value) is acquired.

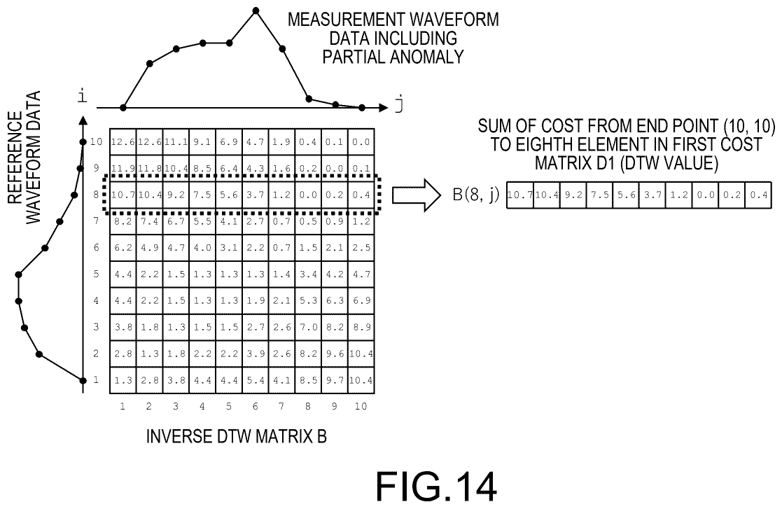

FIG. 14 illustrates an example of the inverse DTW matrix B in a case where M=10, and an example of extracting the value of each element of the (q+2)-th row from the inverse DTW matrix B. For example, in a case where q=6, the inverse DTW value calculator 215a extracts the value of each element in the (6+2=8)-th row of the inverse DTW matrix B.

The forward DTW value calculator 215b calculates the forward DTW value from the starting point (1, 1) to each element of the (q+2)-th row of the second cost matrix D2^{[p,q+1]} based on the already calculated forward DTW value from the starting point (1, 1) to each element of the q-th row of the second cost matrix D2^{[p,q]} and the second cost matrix D2[p,q+1]. The second cost matrix D2^{[p,q]} corresponds to the second distance matrix, and the second cost matrix D2^{[p,q+1]} corresponds to the third distance matrix.

In detail, the forward DTW value calculator 215b calculates the DTW matrix related to [p, q+1] (referred to as the forward DTW matrix A^{[p, q+1]}) based on the second cost matrix D2^{[p,q+1]} and the already calculated DTW matrix for the interval [p, q] (referred to as the forward DTW matrix A^{[p, q]}) according to the following formula. The forward DTW matrix A_{[p, q]} al corresponds to the fourth evaluation matrix in which the DTW values (fourth intermediate evaluation values) are stored in respective elements corresponding to the second data points from at least the first to the q-th data points.

$${A ( i , j )}_{1 \leq i \leq q + 2 , 1 \leq j \leq M}^{[ p , q + 1 ]} = D 2 {( i , j )}^{[ p , q + 1 ]} + min [ \begin{matrix}{A}^{[ p , q + 1 ]} ( i - 1 , j - 1 ) \\ {A}^{[ p , q + 1 ]} ( i - 1 , j ) \\ {A}^{[ p , q + 1 ]} ( i , j - 1 )\end{matrix} ] \qquad [ Math . 8 ]$$

However, the respective elements from the first row to the q-th row of the forward DTW matrix A^{[p, q+1]} is the same as the corresponding elements from the first row to the q-th row of the forward DTW matrix Alp, ql. Thus, in practice, it is sufficient to calculate only the elements of the (q+1)-th and (q+2)-th rows of the forward DTW matrix A^{[p, q+1]}.

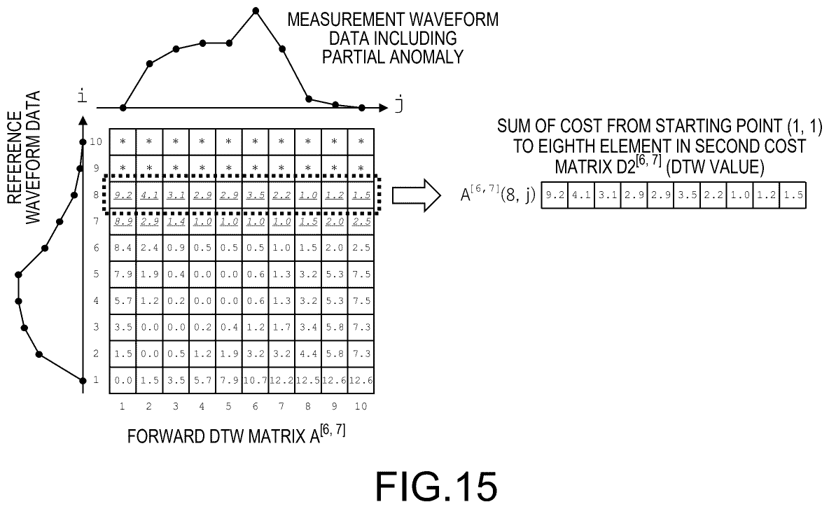

FIG. 15 illustrates an example of the forward DTW matrix A^{[6, 7]} calculated based on the forward DTW matrix A[6, 6] in a case where p=6 and q=6. The elements from the first to the sixth row of the forward DTW matrix A^{[6, 7]} are the same as the already calculated elements from the first to the sixth row of the forward DTW matrix A^{[6, 6]}. Thus, it is sufficient to calculate only the elements of the (6+1=7)-th row and (6+2=8)-th row of the forward DTW matrix A^{[6, 7]}. The value of each element in the eighth row corresponds to a fifth intermediate evaluation value.

The forward DTW value calculator 215b extracts the value of each element in the (q+2)-th row of the forward DTW matrix A^{[p, q+1]} to obtain the forward DTW value (fifth intermediate evaluation value) for the optimal path (the path for which a sum of cost becomes minimum) from the starting point (1, 1) to each element in the (q+2)-th row of the second cost matrix D2^{[p,q+1]}. In the example of FIG. 15, each element of (6+2=8)-th row of the forward DTW matrix A^{[6, 7]} is extracted.

The synthesizer 315c calculates the second similarity S2^{[p, q+1]} based on the inverse DTW value (third intermediate evaluation value) along the optimal path from the end point (M, M) of the first cost matrix D1 calculated by the inverse DTW value calculator 215a to each element of the (q+2)-th row, and the forward DTW value (fifth intermediate evaluation value) along the optimal path from the starting point (1, 1) of the second cost matrix D2^{[p,q+1]} calculated by the forward DTW value calculator 215b to each element of the (q+2)-th row. In other words, the path that combines (synthesizes) these two optimal paths corresponds to the optimal path related to the interval [p, q+1], and the evaluation value of this optimal path (second evaluation value) is the second similarity S2^{[p, q+1]}. The data that includes the correspondence of the first data point and the second data point associated with each element included in the optimal path becomes the second correspondence data.

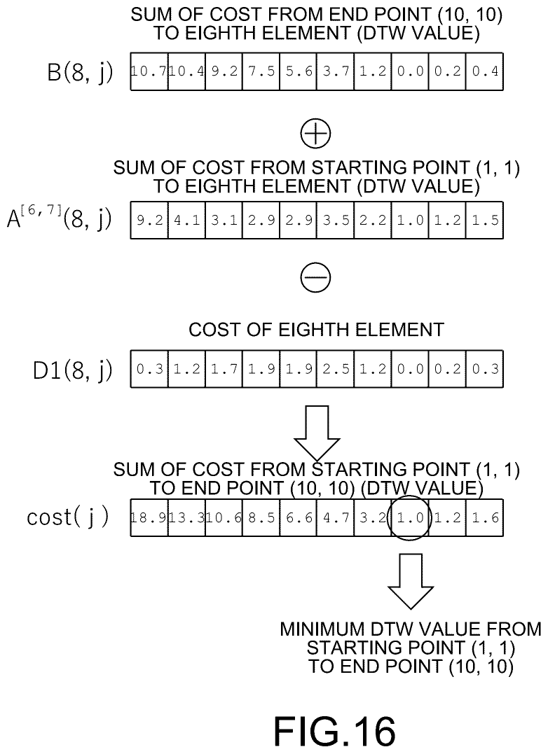

Specifically, as illustrated in FIG. 16, based on B (q+2, j), which corresponds to the inverse DTW value from the end point (M, M) to each element of the (q+2)-th row, A^{[p, q+1]} (q+2, j), which corresponds to the forward DTW value from the starting point (1, 1) to each element of the (q+2)-th row, and D1(q+2, j), which corresponds to the cost (distance) of each element in the (q+2)-th row, where j=1 to M, the synthesizer 315c calculates evaluation vector cost (j) according to the following formula. This formula means to generate a vector in which the calculated value, which is obtained by subtracting the cost (distance) in each element from the sum of the third intermediate evaluation value and the fifth intermediate evaluation value in each element, is stored in a component corresponding to each element.

$$cost {( j )}_{1 \leq j \leq M} = B ( q + 2 , j ) + {A}^{[ p , q + 1 ]} ( q + 2 , j ) - D 1 ( q + 2 , j ) \qquad [ Math . 9 ]$$

The value of each component of the evaluation vector cost (j) calculated in this way corresponds to a sum of cost to reach the end point (M, M) via the element (q+2, j) from the starting point (1, 1). Then, the value of the component with the highest evaluation is selected among these (in the present embodiment, the minimum component value). The value of the selected component represents the minimum sum of cost to reach the end point (M, M) from the starting point (1, 1) of the second cost matrix D2^{[p,q+1]} via the element corresponding to the selected component, that is, the second similarity S2^{[p, q+1]} (second evaluation value) for the second cost matrix D2^{[p,q+1]}.

In the example of FIG. 16, the smallest component among the 10 components of the evaluation vector cost (j) obtained as a result of the synthesis is 1.0, which represents the minimum total cost to reach from the starting point (1, 1) to the end point (10, 10) of the second cost matrix D2[6, 7]. Thus, the synthesizer 215c calculates the second similarity S2^{[6, 7]} as 1.0.

As described above, the information processing apparatus 201 according to Embodiment 2 calculates the second similarity S2^{[p, q+1]} by calculating the inverse DTW value from the end point (M, M) of the first cost matrix D1 to each element of the (q+2)-th row, calculating the forward DTW value from the starting point (1, 1) of the second cost matrix D2^{[p,q+1]} to each element of the (q+2)-th row based on the forward DTW value from the starting point (1, 1) of the second cost matrix D2^{[p, q]} to the q-th row, and synthesizing these forward DTW values and inverse DTW values, when calculating the second similarity S2^{[p, q+1]}.

According to the above characteristics, the information processing apparatus 201 according to Embodiment 2 can calculate the second similarity S2^{[p, q+1]} using the already calculated second similarity S2^{[p, q]}. This makes it possible to reduce a calculation amount when the second similarity S2 is calculated.

### Embodiment 3

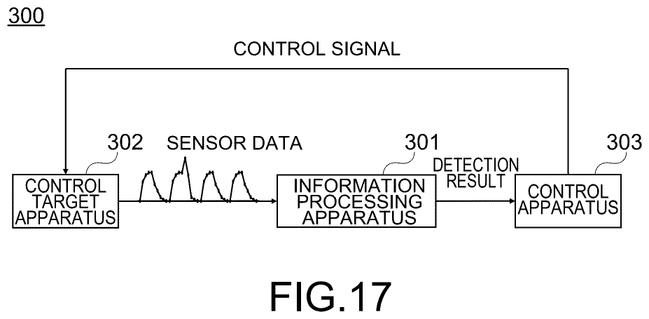

FIG. 17 is a view illustrating a configuration of an information processing system 300 according to Embodiment 3. The information processing system 300 includes a control target apparatus 302 that is a measurement target, an information processing apparatus 301, and a control apparatus 303. The control target apparatus 302 is not particularly limited, but for example, is a propulsion apparatus of a spacecraft. Description will be provided here assuming a case of the propulsion apparatus. Inside the control target apparatus 302, a pressure sensor that is not illustrated in the drawing is mounted, and pressure data obtained by this pressure sensor is input to the information processing apparatus 301 as time-series sensor data (hereinafter, referred to as time-series data). The control apparatus 303 may be part of the information processing apparatus 301 as a controller.

The information processing apparatus 301 is the same as the information processing apparatus 101 or 201 according to Embodiment 1 or 2. The information processing apparatus 301 detects an anomaly included in the time-series data and an interval in which the anomaly exists. The control apparatus 303 adjusts control parameters included in a control signal to be transmitted to the control target apparatus 302 based on the detection result of the information processing apparatus 301. For example, the control apparatus 303 maintains current values of the control parameters while the time-series data is normal, and if an anomaly is detected in the time-series data, changes the values of the control parameters according to the interval in which the anomaly exists. In addition, the control apparatus 303 transmits a control signal to stop the propulsion apparatus 302 in a case where an anomaly included in the time-series data is a critical anomaly indicating a failure of the propulsion apparatus 302.

### (Hardware Configuration)

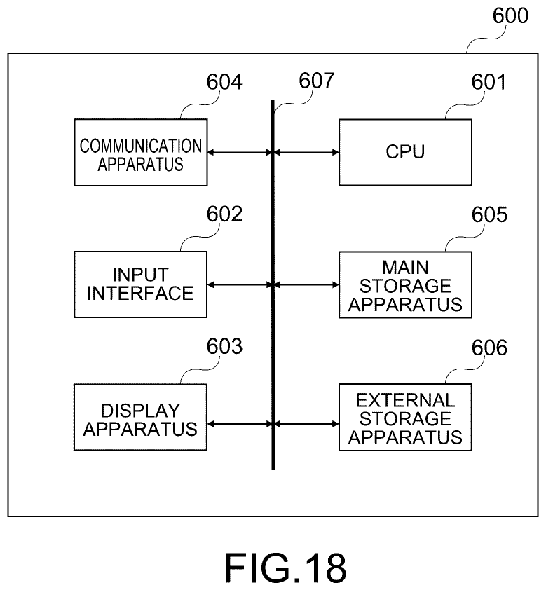

FIG. 18 illustrates a hardware configuration of the information processing apparatus 101, 201 and 301 according to each embodiment. The information processing apparatus 101, 201 and 301 are configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional composition of the present device. The information processing program may be achieved by a combination of a plurality of computer programs and scripts instead of one computer program. Each functional composition is achieved as the CPU 601 executes the information processing program.

The input interface 602 is a circuit for inputting to the present device 101, 201 and 301, an operation signal from an input device such as a keyboard, a mouse, or a touch panel.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603. The display device 603 corresponds to the output device 17 in the device 101, 201 and 301.

The communication device 604 is a circuit for the present device to communicate with an external device in a wireless or wired manner. Data can be input from the external device through the communication device 604. The data input from the external device can be stored in the main storage device 605 or the external storage device 606. The communication device 604 corresponds to the data acquirer 10 in the device 101, 201 and 301.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing apparatus 101, 201 and 301 in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing apparatus 101, 201 and 301 in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The information processing apparatus 101, 201 and 301 may be configured as a single computer device 600 or may be configured as a system including a plurality of mutually connected computer devices 600.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments of the present invention can also be configured as follows.

### CLAUSES

Clause 1. An information processing apparatus, comprising processing circuitry configured to:
generate first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determine one or more corresponding second data points for each of the first data points based on the first distance information to generate first correspondence data in which the first data points are associated with the second data points;
replace a distance between at least one target data point and one or more of the first data points with a setting value corresponding to each target data point to generate second distance information, the at least one target data point being at least one second data point selected from the plurality of second data points;
determine one or more corresponding second data points for each of the first data points based on the second distance information to generate second correspondence data in which the first data points are associated with the second data points; and
evaluate the measurement waveform data based on the first correspondence data and the second correspondence data to detect an interval in which the measurement target is in the second state in the measurement waveform data.

Clause 2. The information processing apparatus according to Clause 1, wherein the setting value has a value according to an expected range of distances to the first data points associated with the target data point when the measurement target is in the first state.

Clause 3. The information processing apparatus according to Clause 1 or 2, wherein
the processing circuitry calculates a first evaluation value using a sum of the distances between the first data points and the second data points based on the first correspondence data,
calculates a second evaluation value using a sum of the distances between the first data points and the second data points based on the second correspondence data, and
determines whether there is an interval in which the measurement target is in the second state in the measurement waveform data, based on the first evaluation value and the second evaluation value.

Clause 4. The information processing apparatus according to Clause 3, wherein the processing circuitry determines that there is an interval in which the measurement target is in the second state in the measurement waveform data, in a case where a difference between the first evaluation value and the second evaluation value is equal to or greater than a threshold.

Clause 5. The information processing apparatus according to Clause 3 or 4, wherein in a case where the processing circuitry determines that there is an interval in which the measurement target is in the second state, the processing circuitry detects an interval of the measurement waveform data that includes the first data points associated with the target data point in the second correspondence data as the interval in which the measurement target is in the second state.

6. The information processing apparatus according to any one of Clauses 1 to 5, wherein
the processing circuitry calculates the first correspondence data by searching for one or more second data points corresponding to the first data points based on the first distance information so that a sum of the distances to the corresponding second data points is minimized and all the second data points are associated, and
calculates the second correspondence data by searching for one or more second data points corresponding to the first data points based on the second distance information so that a sum of the distances to the corresponding second data points is minimized and all the second data points are associated.

Clause 7. The information processing apparatus according to Clause 6, wherein the processing circuitry calculates the first correspondence data using DTW and calculates the second correspondence data using the DTW.

Clause 8. The information processing apparatus according to any one of Clauses 1 to 7, wherein the processing circuitry generates the second distance information by replacing the distances to all the first data points corresponding to the target data point in the first distance information with the setting value.

Clause 9. The information processing apparatus according to any one of Clauses 3 to 5, wherein
the processing circuitry selects the second data points from the p-th to the q-th data points among the plurality of second data points as target data points for a plurality of combinations of p and q to calculate a plurality of the second evaluation values for each combination of the values of p and q, and
selects one of the second evaluation values based on the second evaluation values and evaluates the measurement waveform data based on the second correspondence data used to calculate the selected second evaluation value.

Clause 10. The information processing apparatus according to Clause 9, wherein the processing circuitry selects the second evaluation value with the highest evaluation among the second evaluation values.

Clause 11. The information processing apparatus according to Clause 9 or 10, wherein the processing circuitry generates the second distance information by replacing the distances to all the first data points corresponding to the target data points with the setting values for each combination of p and q.

Clause 12. The information processing apparatus according to any one of Clauses 9 to 11, wherein
the processing circuitry generates, as the first distance information, a first distance matrix in which distances between the first data points and the second data points are stored in elements corresponding to pairs of the first data points and the second data points,
performing sequential tracing of adjacent elements from a first starting point that is an element corresponding to a pair of the last first data point and the last second data point in the first distance matrix to reach another element and generating a third evaluation matrix in which a third intermediate evaluation value being a sum of distances of elements included in a path that minimizes a sum of the distances is stored in said another element,
generates a second distance matrix being the second distance information by replacing values of elements corresponding to the target data points that are the p-th to the q-th of the second data points in the first distance matrix with the setting values,
performing sequential tracing of adjacent elements from a second starting point that is an element corresponding to the initial first data point and the initial second data point in the second distance matrix to reach elements corresponding to the first to the q-th of the second data points and generating a fourth evaluation matrix in which a fourth intermediate evaluation value being a sum of distances of elements included in a path that minimizes a sum of the distances is stored in the elements,
generates a third distance matrix as the second distance information by replacing values of elements corresponding to the target data points that are the p-th to the (q+1)-th of the second data points in the first distance matrix with the setting values,
performing sequential tracing of adjacent elements from a third starting point that is an element corresponding to the initial first data point and the initial second data point in the third distance matrix to reach elements corresponding to the (q+2)-th second data point using the fourth evaluation matrix and calculates a fifth intermediate evaluation value being a sum of distances of the elements included in a path that minimizes a sum of the distances,
acquires the third intermediate evaluation value of the elements corresponding to the (q+2)-th second data point based on the third evaluation matrix, and
selects an element from the elements corresponding to the (q+2)-th second data point based on the fifth intermediate evaluation value and the third intermediate evaluation value and calculates the second evaluation value for the third distance matrix based on the fifth intermediate evaluation value and the third intermediate evaluation value of the selected element.

Clause 13. The information processing apparatus according to Clause 12, wherein the processing circuitry calculates values obtained by subtracting the distances in the respective elements of the second distance information from a sum of the fifth intermediate evaluation value and the third intermediate evaluation value in the respective elements and a value with the highest evaluation among the calculated values is the second evaluation value for the third distance matrix.

Clause 14. The information processing apparatus according to Clause 12 or 13, the processing circuitry generates a path obtained by synthesizing a first path that is a path from the third starting point to the selected element in the third distance matrix, and a second path that is a path from the first starting point to the selected element in the third evaluation matrix, and correspondence of the first data points and the second data points associated with elements included in the generated path is the second correspondence data.

Clause 15. The information processing apparatus according to any one of Clauses 1 to 14, wherein the reference waveform data is created by calculating a centroid waveform of a plurality of pieces of test waveform data related to the first state.

Clause 16. The information processing apparatus according to any one of Clauses 1 to 15, wherein for each of a plurality of pieces of test waveform data that include a plurality of third data points related to the first state, third data points corresponding to the second data points are determined, the setting value is set based on an average and a standard deviation of the distances between the second data points of the reference waveform data and the corresponding third data points.

Clause 17. The information processing apparatus according to any one of Clauses 1 to 16, wherein
the first state is a normal state, and
the second state is an anomaly state.

Clause 18. The information processing apparatus according to any one of Clauses 1 to 17, wherein the processing circuitry acquires the measurement waveform data from a sensor that senses the measurement target.

Clause 19. The information processing apparatus according to Clause 18, wherein the processing circuitry sequentially extracts, as the measurement waveform data, data for each period from periodic time-series data detected by the sensor.

Clause 20. The information processing apparatus according to Clause 18 or 19, comprising controlling circuitry configured to control the measurement target based on a state of the measurement target in the interval determined by the processing circuitry.

Clause 21. An information processing method, comprising:
generating first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determining one or more corresponding second data points for each of the first data points based on the first distance information to generate first correspondence data in which the first data points are associated with the second data points;
replacing a distance between at least one target data point and one or more of the first data points with a setting value corresponding to each target data point to generate second distance information, the at least one target data point being at least one second data point selected from the plurality of second data points;
determining one or more corresponding second data points for each of the first data points based on the second distance information to generate second correspondence data in which the first data points are associated with the second data points; and
evaluating the measurement waveform data based on the first correspondence data and the second correspondence data to detect an interval in which the measurement target is in the second state in the measurement waveform data.

Clause 22. A non-transitory computer readable medium having a computer program stored therein which causes a computer to perform processes comprising:
generating first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determining one or more corresponding second data points for each of the first data points based on the first distance information to generate first correspondence data in which the first data points are associated with the second data points;
replacing a distance between at least one target data point and one or more of the first data points with a setting value corresponding to each target data point to generate second distance information, the at least one target data point being at least one second data point selected from the plurality of second data points;
determining one or more corresponding second data points for each of the first data points based on the second distance information to generate second correspondence data in which the first data points are associated with the second data points; and
evaluating the measurement waveform data based on the first correspondence data and the second correspondence data to detect an interval in which the measurement target is in the second state in the measurement waveform data.

1. An information processing apparatus, comprising processing circuitry configured to:
generate first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determine one or more corresponding second data points for each of the first data points based on the first distance information to generate first correspondence data in which the first data points are associated with the second data points;
replace a distance between at least one target data point and one or more of the first data points with a setting value corresponding to each target data point to generate second distance information, the at least one target data point being at least one second data point selected from the plurality of second data points;
determine one or more corresponding second data points for each of the first data points based on the second distance information to generate second correspondence data in which the first data points are associated with the second data points; and
evaluate the measurement waveform data based on the first correspondence data and the second correspondence data to detect an interval in which the measurement target is in the second state in the measurement waveform data.

2. The information processing apparatus according to claim 1, wherein the setting value has a value according to an expected range of distances to the first data points associated with the target data point when the measurement target is in the first state.

3. The information processing apparatus according to claim 1, wherein
the processing circuitry calculates a first evaluation value using a sum of the distances between the first data points and the second data points based on the first correspondence data,
calculates a second evaluation value using a sum of the distances between the first data points and the second data points based on the second correspondence data, and
determines whether there is an interval in which the measurement target is in the second state in the measurement waveform data, based on the first evaluation value and the second evaluation value.

4. The information processing apparatus according to claim 3, wherein the processing circuitry determines that there is an interval in which the measurement target is in the second state in the measurement waveform data, in a case where a difference between the first evaluation value and the second evaluation value is equal to or greater than a threshold.

5. The information processing apparatus according to claim 3, wherein in a case where the processing circuitry determines that there is an interval in which the measurement target is in the second state, the processing circuitry detects an interval of the measurement waveform data that includes the first data points associated with the target data point in the second correspondence data as the interval in which the measurement target is in the second state.

6. The information processing apparatus according to claim 1, wherein
the processing circuitry calculates the first correspondence data by searching for one or more second data points corresponding to the first data points based on the first distance information so that a sum of the distances to the corresponding second data points is minimized and all the second data points are associated, and
calculates the second correspondence data by searching for one or more second data points corresponding to the first data points based on the second distance information so that a sum of the distances to the corresponding second data points is minimized and all the second data points are associated.

7. The information processing apparatus according to claim 6, wherein the processing circuitry calculates the first correspondence data using DTW and calculates the second correspondence data using the DTW.

8. The information processing apparatus according to claim 1, wherein the processing circuitry generates the second distance information by replacing the distances to all the first data points corresponding to the target data point in the first distance information with the setting value.

9. The information processing apparatus according to claim 3, wherein
the processing circuitry selects the second data points from the p-th to the q-th data points among the plurality of second data points as target data points for a plurality of combinations of p and q to calculate a plurality of the second evaluation values for each combination of the values of p and q, and
selects one of the second evaluation values based on the second evaluation values and evaluates the measurement waveform data based on the second correspondence data used to calculate the selected second evaluation value.

10. The information processing apparatus according to claim 9, wherein the processing circuitry selects the second evaluation value with the highest evaluation among the second evaluation values.

11. The information processing apparatus according to claim 9, wherein the processing circuitry generates the second distance information by replacing the distances to all the first data points corresponding to the target data points with the setting values for each combination of p and q.

12. The information processing apparatus according to claim 9, wherein
the processing circuitry generates, as the first distance information, a first distance matrix in which distances between the first data points and the second data points are stored in elements corresponding to pairs of the first data points and the second data points,
performing sequential tracing of adjacent elements from a first starting point that is an element corresponding to a pair of the last first data point and the last second data point in the first distance matrix to reach another element and generating a third evaluation matrix in which a third intermediate evaluation value being a sum of distances of elements included in a path that minimizes a sum of the distances is stored in said another element,
generates a second distance matrix being the second distance information by replacing values of elements corresponding to the target data points that are the p-th to the q-th of the second data points in the first distance matrix with the setting values,
performing sequential tracing of adjacent elements from a second starting point that is an element corresponding to the initial first data point and the initial second data point in the second distance matrix to reach elements corresponding to the first to the q-th of the second data points and generating a fourth evaluation matrix in which a fourth intermediate evaluation value being a sum of distances of elements included in a path that minimizes a sum of the distances is stored in the elements,
generates a third distance matrix as the second distance information by replacing values of elements corresponding to the target data points that are the p-th to the (q+1)-th of the second data points in the first distance matrix with the setting values,
performing sequential tracing of adjacent elements from a third starting point that is an element corresponding to the initial first data point and the initial second data point in the third distance matrix to reach elements corresponding to the (q+2)-th second data point using the fourth evaluation matrix and calculates a fifth intermediate evaluation value being a sum of distances of the elements included in a path that minimizes a sum of the distances,
acquires the third intermediate evaluation value of the elements corresponding to the (q+2)-th second data point based on the third evaluation matrix, and
selects an element from the elements corresponding to the (q+2)-th second data point based on the fifth intermediate evaluation value and the third intermediate evaluation value and calculates the second evaluation value for the third distance matrix based on the fifth intermediate evaluation value and the third intermediate evaluation value of the selected element.

13. The information processing apparatus according to claim 12, wherein the processing circuitry calculates values obtained by subtracting the distances in the respective elements of the second distance information from a sum of the fifth intermediate evaluation value and the third intermediate evaluation value in the respective elements and a value with the highest evaluation among the calculated values is the second evaluation value for the third distance matrix.

14. The information processing apparatus according to claim 12, the processing circuitry generates a path obtained by synthesizing a first path that is a path from the third starting point to the selected element in the third distance matrix, and a second path that is a path from the first starting point to the selected element in the third evaluation matrix, and correspondence of the first data points and the second data points associated with elements included in the generated path is the second correspondence data.

15. The information processing apparatus according to claim 1, wherein the reference waveform data is created by calculating a centroid waveform of a plurality of pieces of test waveform data related to the first state.

16. The information processing apparatus according to claim 2, wherein for each of a plurality of pieces of test waveform data that include a plurality of third data points related to the first state, third data points corresponding to the second data points are determined, and the setting value is set based on an average and a standard deviation of the distances between the second data points of the reference waveform data and the corresponding third data points.

17. The information processing apparatus according to claim 1, wherein
the first state is a normal state, and
the second state is an anomaly state.

18. The information processing apparatus according to claim 1, wherein the processing circuitry acquires the measurement waveform data from a sensor that senses the measurement target.

19. The information processing apparatus according to claim 18, wherein the processing circuitry sequentially extracts, as the measurement waveform data, data for each period from periodic time-series data detected by the sensor.

20. The information processing apparatus according to claim 18, comprising controlling circuitry configured to control the measurement target based on a state of the measurement target in the interval determined by the processing circuitry.

21. An information processing method, comprising:
generating first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determining one or more corresponding second data points for each of the first data points based on the first distance information to generate first correspondence data in which the first data points are associated with the second data points;
replacing a distance between at least one target data point and one or more of the first data points with a setting value corresponding to each target data point to generate second distance information, the at least one target data point being at least one second data point selected from the plurality of second data points;
determining one or more corresponding second data points for each of the first data points based on the second distance information to generate second correspondence data in which the first data points are associated with the second data points; and
evaluating the measurement waveform data based on the first correspondence data and the second correspondence data to detect an interval in which the measurement target is in the second state in the measurement waveform data.

22. A non-transitory computer readable medium having a computer program stored therein which causes a computer to perform processes comprising:
generating first distance information based on measurement waveform data and reference waveform data, the measurement waveform data including a plurality of first data points related to a measurement target that can transition between a first state and a second state, the reference waveform data including a plurality of second data points related to the first state, the first distance information including distances between the first data points and the second data points;
determining one or more corresponding second data points for each of the first data points based on the first distance information to generate first correspondence data in which the first data points are associated with the second data points;
replacing a distance between at least one target data point and one or more of the first data points with a setting value corresponding to each target data point to generate second distance information, the at least one target data point being at least one second data point selected from the plurality of second data points;
determining one or more corresponding second data points for each of the first data points based on the second distance information to generate second correspondence data in which the first data points are associated with the second data points; and
evaluating the measurement waveform data based on the first correspondence data and the second correspondence data to detect an interval in which the measurement target is in the second state in the measurement waveform data.
